(19) United States
(12) Patent Application Publication
(10) Pub. No.: US 2026/0360935 A1
(43) Pub. Date: Nov. 12, 2026

(54) BUSBAR ASSEMBLY AND BATTERY PACK

(71) Applicant: EVE ENERGY STORAGE CO., LTD., Wuhan (CN)

(72) Inventor: Shaobo YOU, Wuhan (CN)

(73) Assignee: EVE ENERGY STORAGE CO., LTD., Wuhan (CN)

(21) Appl. No.: 19/716,494

(22) Filed: Jun. 23, 2026

Related U.S. Application Data
(63) Continuation of application No. PCT/CN2024/103269, filed on Jul. 3, 2024.

(30) Foreign Application Priority Data
Dec. 27, 2023 (CN) 202323620256.6

(51) Int. Cl. H01M 50/507; H01M 10/48; H01M 50/516

(52) U.S. Cl. CPC H01M 50/507; H01M 10/482; H01M 10/486; H01M 50/516

(57) ABSTRACT

A busbar assembly and a battery pack are provided. The busbar assembly includes a busbar body and a temperature acquisition element. The busbar body is provided with a positioning groove and a welding groove. The welding groove is configured to be welded to a pole terminal of a cell. A spacing is reserved between the positioning groove and the welding groove. The temperature acquisition element is adhesively fixed in the positioning groove.

### RELATED APPLICATION(S)

The present disclosure is a continuation application of International application No. PCT/CN2024/103269, filed on Jul. 3, 2024, which claims priority to Chinese Patent Application No. 202323620256.6, filed on Dec. 27, 2023. The entire disclosure of the prior applications is hereby incorporated by reference.

### TECHNICAL FIELD

The present disclosure relates to the technical field of batteries, and in particular, to a busbar assembly and a battery pack.

### BACKGROUND

Existing busbars in the market are connected with temperature acquisition elements, which facilitates monitoring battery temperature through the busbars and feeding data back to a battery management system (BMS), enabling the BMS to implement corresponding control strategies. Currently, temperature acquisition elements are typically assembled to the busbars using adhesive dispensing processes. However, such processes rely heavily on operator experience and assembly verification as the basis for execution. Therefore, during actual adhesive dispensing processes, it is found that adhesive tends to overflow into welding grooves of the busbars, which contaminates welding areas, causing problems such as false welding and insufficient weld strength, thus affecting welding effect. Therefore, existing techniques face challenges in rapidly positioning and assembling temperature acquisition elements to reduce operational difficulty and improve assembly efficiency.

### SUMMARY

According to a first aspect, the present disclosure provides a busbar assembly, which includes a busbar body and a temperature acquisition element. The busbar body is provided with a positioning groove and a welding groove. The welding groove is configured to be welded to a pole terminal of a cell. A spacing is reserved between the positioning groove and the welding groove. The temperature acquisition element is adhesively fixed in the positioning groove.

According to a second aspect, the present disclosure provides a battery pack which includes the busbar assembly described above.

### BRIEF DESCRIPTION OF THE DRAWINGS

FIG. 1 is a schematic structural diagram of a busbar assembly according to an aspect of the present disclosure;

FIG. 2 is a schematic structural diagram of a busbar assembly according to an aspect of the present disclosure;

FIG. 3 is a schematic structural diagram of a busbar assembly according to an aspect of the present disclosure;

FIG. 4 is a schematic structural diagram of a busbar assembly according to an aspect of the present disclosure;

FIG. 5 is a schematic diagram of a battery pack according to an aspect of the present disclosure.

Reference numerals: 1000, battery pack; 100, busbar assembly; 1, busbar body; 11, positioning groove; 12, welding groove; 13, first bus plate; 14, second bus plate; 2, regional partition line; 21, arc segment; 22, linear segment; 3, first region; 31, first sub-region; 32, third sub-region; 4, second region; 41, second sub-region; 42, fourth sub-region; 5, temperature acquisition element; 6, pressure acquisition element; 200, cell.

### DETAILED DESCRIPTION

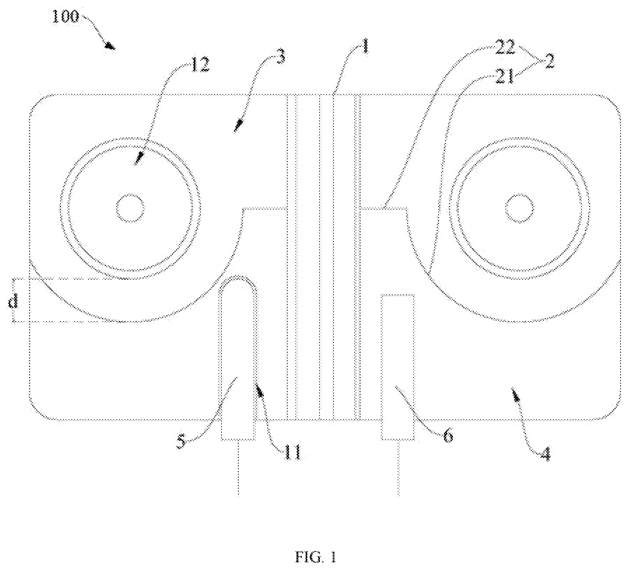

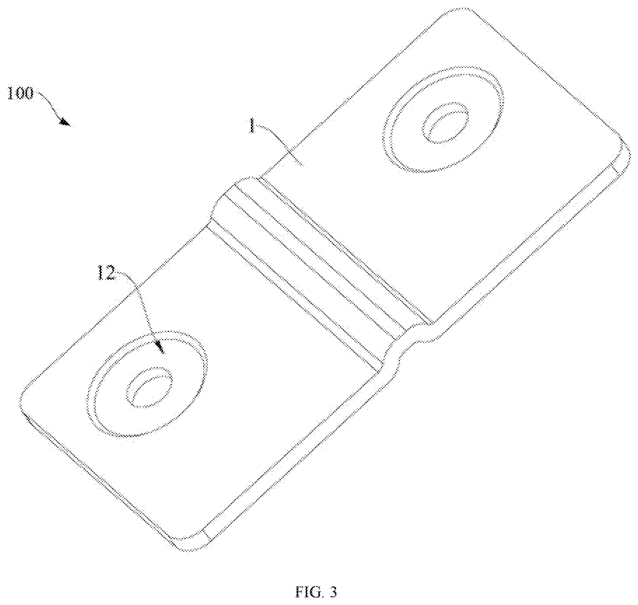

Referring to FIG. 1 to FIG. 4, examples of the present disclosure disclose a busbar assembly 100.

Referring to FIG. 1, the busbar assembly 100 includes a busbar body 1 and a temperature acquisition element 5. The busbar body 1 is provided with a positioning groove 11 and a welding groove 12. The welding groove 12 is configured to be welded to a pole terminal of a cell. A spacing is reserved between the positioning groove 11 and the welding groove 12. The temperature acquisition element 5 is adhesively fixed in the positioning groove 11.

The inventor of the present disclosure found that in existing busbar assembly processes, the temperature acquisition element 5 is typically assembled to the busbar using adhesive dispensing processes, which causes adhesive to tend to overflow into the welding groove 12 of the busbar, resulting in contamination of welding areas, causing problems such as false welding and insufficient weld strength, thus affecting welding effect. Based on this, in the busbar assembly 100 of the present disclosure, by providing the positioning groove 11 on the busbar body 1, with a spacing is reserved between the positioning groove 11 and the welding groove 12, when fixing the temperature acquisition element 5 to the positioning groove 11, the adhesive can be greatly confined within the positioning groove 11, thereby preventing the adhesive from overflowing into the welding groove 12, and facilitating subsequent welding operations. Meanwhile, by providing the positioning groove 11 on the busbar body 1 to receive the temperature acquisition element 5, the temperature acquisition element 5 can be rapidly positioned and assembled, thereby reducing the operational difficulty and improving assembly efficiency.

In an aspect, the temperature acquisition element 5 may be a temperature sensor, and a shape of the positioning groove 11 corresponds to that of the temperature sensor, for example, rectangular or circular. In the illustrated example, the positioning groove 11 is of an elongated rectangular shape.

Referring to FIG. 1, in an aspect of the present disclosure, the busbar body 1 is provided with a regional partition line 2, which divides a top surface of the busbar body 1 into a first region 3 and a second region 4. The welding groove 12 is provided in the first region 3, while the positioning groove 11 is provided in the second region 4. By this arrangement, the top surface of the busbar body 1 can be divided into the first region 3 and the second region 4. The first region 3 is provided with the welding groove 12 and serves as a welding area, while the second region 4 is provided with the positioning groove 11 and serves as an assembly area for the temperature acquisition element 5. This partition can visually guide operators to designate areas for specific operations. On the one hand, the operational difficulty can be reduced and the assembly efficiency can be improved. On the other hand, the temperature acquisition element 5 can be kept away from the welding area, which can better protect the temperature acquisition element 5 and also simplify welding fixtures alignment.

Referring to FIG. 1, in an aspect of the present disclosure, a minimum spacing between the regional partition line 2 and the welding groove 12 is 6 mm. By this arrangement, it is found in actual welding that, controlling the spacing between the regional partition line 2 and the welding groove 12 to 6 mm or more can provide sufficient welding space for subsequent welding operations of the welding groove 12, thereby reducing operational difficulty and improving assembly efficiency. It is also more convenient for the positioning of welding fixtures. Moreover, the temperature acquisition element 5 will be farther away from the welding area, which can better protect the temperature acquisition element 5 from thermal interference.

In an aspect, the regional partition line 2 is formed by protruding from the busbar body 1. In this way, the regional partition line 2 and the busbar body 1 are integrally formed, and can be specifically manufactured through a pressing process. By pressing out the protruding regional partition line 2 on the busbar body 1, so that the regional partition line 2 can be directly machined on the busbar body 1, thereby improving work efficiency.

In an aspect, the regional partition line 2 can also be injection molding on the busbar body 1. In this way, the regional partition line 2 is molded onto the busbar body 1 using injection molding, which is mature and convenient for manufacturing and production.

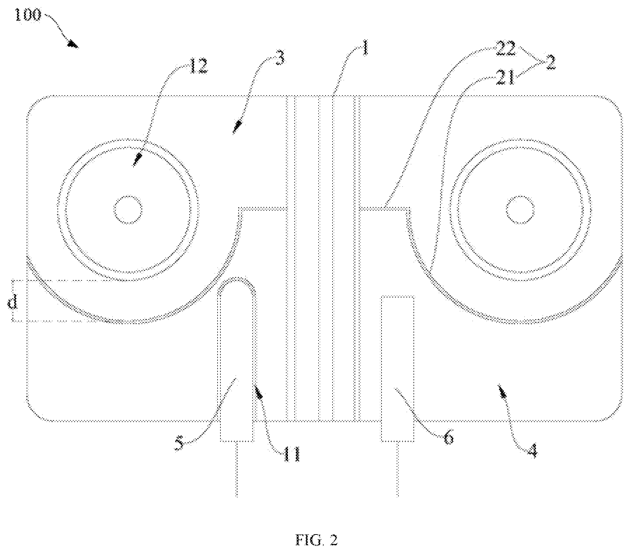

Referring to FIG. 2, in an aspect of the present disclosure, the top surface of the busbar body 1 is provided with a concave region and a convex region protruding from the concave region, and a boundary line between the concave region and the convex region serves as the regional partition line 2. One of the first region 3 and the second region 4 is formed as the concave region, while the other one of the first region 3 and the second region 4 is formed as the convex region. The concave region is formed concavely on the top surface of the busbar body 1. This stepped design enhances partition visibility and operational intuitiveness, making the first region 3 and the second region 4 on the top surface of the busbar body 1 more obvious. The busbar assembly 100 of the present disclosure utilizes the regional partition line 2 to divide the top surface of the busbar body 1 into distinct regions, ensuring visual and tactile identification between regions, allowing operators to more intuitively identify each region and perform corresponding operations within designated areas, thereby further reducing the operational difficulty and improving assembly efficiency.

In the illustrated examples, the first region 3 is the concave region, and the welding groove 12 is provided in the concave region; while the second region 4 is the convex region, and the positioning groove 11 is provided in the convex region.

In an aspect, the second region 4 is the concave region, and the positioning groove 11 is provided in the concave region; while the first region 3 is the convex region, and the welding groove 12 is provided in the convex region.

Referring to FIGS. 1 and 2, in an aspect of the present disclosure, the regional partition line 2 includes an arc segment 21 and a linear segment 22 that are connected to each other. The arc segment 21 and the welding groove 12 are arranged concentrically. By this arrangement, the structure is simple, the manufacturing and production are facilitated, and the manufacturing difficulty is reduced; and at the same time, the structure is more compact, thereby facilitating the miniaturized design of the busbar.

Referring to FIGS. 1 and 2, in an aspect of the present disclosure, the arc segment 21 is a semicircle extending from an edge of the busbar body 1 to the linear segment 22. By this arrangement, the structure is simple, the manufacturing and production are facilitated, the manufacturing difficulty is reduced, and at the same time, welding fixtures alignment is facilitated.

Referring to FIGS. 1 and 2, in an aspect of the present disclosure, a minimum spacing between the arc segment 21 and the welding groove 12 is 6 mm. In the examples shown in FIGS. 1 and 2, the minimum spacing between the arc segment 21 and the welding groove 12 is d, i. e., d≥6 mm.

By this arrangement, it is found in actual welding that, controlling the spacing between the arc segment 21 and the welding groove 12 to be 6 mm or more can provide sufficient welding space for subsequent welding operations of the welding groove 12, thereby reducing operational difficulty and improving assembly efficiency. It is also more convenient for the positioning of welding fixtures. Moreover, the temperature acquisition element 5 will be farther away from the welding area, which can better protect the temperature acquisition element 5 from thermal interference.

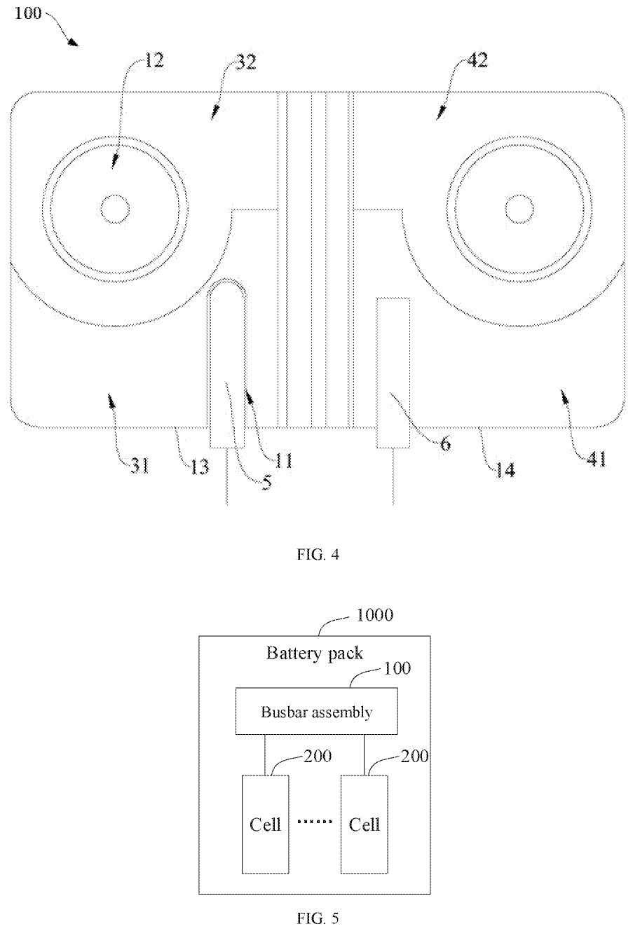

Referring to FIG. 4, in an aspect of the present disclosure, the busbar body 1 includes a first bus plate 13 and a second bus plate 14 that are connected to each other. The positioning groove 11 is provided on the first bus plate 13. The busbar assembly 100 further includes a pressure acquisition element 6 mounted on the second bus plate 14. Two welding grooves 12 are provided, and the two welding grooves 12 are provided on the first bus plate 13 and the second bus plate 14 in one-to-one correspondence. By providing the pressure acquisition element 6 and the temperature acquisition element 5 on the busbar body 1, which can serve as a voltage collection point and a temperature collection point of the busbar body 1, the temperature and pressure of a battery can be monitored simultaneously, and data can be fed back to a BMS, enabling the BMS to implement corresponding control strategies, and the safety of the battery can be improved.

Referring to FIG. 4, in an aspect of the present disclosure, two regional partition lines 2 are provided, and the two regional partition lines 2 are provided on the first bus plate 13 and the second bus plate 14 in one-to-one correspondence. The regional partition line 2 on the first bus plate 13 divides a top surface of the first bus plate 13 into a first sub-region 31 and a second sub-region 41. The positioning groove 11 is provided in the first sub-region 31, while the welding groove 12 on the first bus plate 13 is provided in the second sub-region 41. The regional partition line 2 on the second bus plate 14 divides a top surface of the second bus plate 14 into a third sub-region 32 and a fourth sub-region 42. The pressure acquisition element 6 is mounted in the third sub-region 32, while the welding groove 12 on the second bus plate 14 is provided in the fourth sub-region 42. By this arrangement, the temperature acquisition element 5 and the pressure acquisition element 6 are distanced from the two welding grooves 12 in a one-to-one manner, so that the temperature acquisition element 5 and the pressure acquisition element 6 can be better protected.

In an aspect, the first sub-region 31 and the third sub-region 32 constitute the first region 3, and the second sub-region 41 and the fourth sub-region 42 constitute the second region 4.

Referring to FIG. 4, in an aspect of the present disclosure, the two regional partition lines 2 are arranged symmetrically. This arrangement is simple in structure, facilitates manufacturing and production, and reduces manufacturing difficulty.

Referring to FIG. 5, the present disclosure further discloses a battery pack 1000, which includes the busbar assembly 100 described above and at least one cell 200. The welding groove 12 provided on the busbar body 1 of the busbar assembly 100 is configured to be welded to a pole terminal of the cell 200. In an aspect, the positioning groove 11 is provided on the busbar body 1, and a spacing is reserved between the positioning groove 11 and the welding groove 12, therefore, when fixing the temperature acquisition element 5 to the positioning groove 11, the adhesive can be greatly confined within the positioning groove 11, thereby preventing the adhesive from overflowing into the welding groove 12, and facilitating subsequent welding operations. Meanwhile, by providing the positioning groove 11 on the busbar body 1 to receive the temperature acquisition element 5, the temperature acquisition element 5 can be rapidly positioned and assembled, thereby reducing the operational difficulty and improving assembly efficiency.

What is claimed is:

1. A busbar assembly comprising:
a busbar body including a positioning groove and a welding groove;
the welding groove being welded to a pole terminal of a cell;
a spacing being formed between the positioning groove and the welding groove; and
a temperature acquisition element being adhesively fixed in the positioning groove.

2. The busbar assembly according to claim 1, wherein
the busbar body includes a regional partition line;
the regional partition line divides a top surface of the busbar body into a first region and a second region; and
the welding groove is located in the first region, and the positioning groove is located in the second region.

3. The busbar assembly according to claim 2, wherein a minimum spacing between the regional partition line and the welding groove is 6 mm.

4. The busbar assembly according to claim 2, wherein
the regional partition line is formed by protruding from the busbar body; or
the regional partition line is formed by injection molding on the busbar body.

5. The busbar assembly according to claim 2, wherein
the first region is a concave region, and the second region is a convex region.

6. The busbar assembly according to claim 2, wherein
the regional partition line comprises an arc segment and a linear segment; and
the arc segment and the welding groove are arranged concentrically.

7. The busbar assembly according to claim 3, wherein
the regional partition line comprises an arc segment and a linear segment; and
the arc segment and the welding groove are arranged concentrically.

8. The busbar assembly according to claim 4, wherein
the regional partition line comprises an arc segment and a linear segment; and
the arc segment and the welding groove are arranged concentrically.

9. The busbar assembly according to claim 5, wherein
the regional partition line comprises an arc segment and a linear segment; and
the arc segment and the welding groove are arranged concentrically.

10. The busbar assembly according to claim 6, wherein
the arc segment is a semicircle extending from an edge of the busbar body to the linear segment; and
a minimum spacing between the arc segment and the welding groove is 6 mm.

11. The busbar assembly according to claim 7, wherein
the arc segment is a semicircle extending from an edge of the busbar body to the linear segment; and
a minimum spacing between the arc segment and the welding groove is 6 mm.

12. The busbar assembly according to claim 8, wherein
the arc segment is a semicircle extending from an edge of the busbar body to the linear segment; and
a minimum spacing between the arc segment and the welding groove is 6 mm.

13. The busbar assembly according to claim 9, wherein
the arc segment is a semicircle extending from an edge of the busbar body to the linear segment; and
a minimum spacing between the arc segment and the welding groove is 6 mm.

14. The busbar assembly according to claim 6, wherein
the busbar body comprises a first bus plate and a second bus plate, and the positioning groove is provided on the first bus plate;
each of the first bus plate and the second bus plate is provided with the welding groove; and
the busbar assembly further comprises a pressure acquisition element mounted on the second bus plate.

15. The busbar assembly according to claim 7, wherein
the busbar body comprises a first bus plate and a second bus plate, and the positioning groove is provided on the first bus plate;
each of the first bus plate and the second bus plate is provided with the welding groove; and
the busbar assembly further comprises a pressure acquisition element mounted on the second bus plate.

16. The busbar assembly according to claim 10, wherein
the busbar body comprises a first bus plate and a second bus plate, and the positioning groove is provided on the first bus plate;
each of the first bus plate and the second bus plate is provided with the welding groove; and
the busbar assembly further comprises a pressure acquisition element mounted on the second bus plate.

17. The busbar assembly according to claim 16, wherein
the regional partition line includes a first section on the first bus plate and a second section on the second bus plate;
the first section of the regional partition line divides a top surface of the first bus plate into a first sub-region and a second sub-region, the positioning groove is provided in the first sub-region, and the welding groove on the first bus plate is provided in the second sub-region;
the second section of the regional partition line divides a top surface of the second bus plate into a third sub-region and a fourth sub-region, the pressure acquisition element is mounted in the third sub-region, and the welding groove on the second bus plate is provided in the fourth sub-region; and
the first section of the regional partition lines and the second section of the regional partition lines are arranged symmetrically.

18. A battery pack comprising:
at least one cell;
a busbar assembly including
a busbar body including a positioning groove and a welding groove,
the welding groove being welded to a pole terminal of a cell,
a spacing being formed between the positioning groove and the welding groove, and
a temperature acquisition element being adhesively fixed in the positioning groove; and
wherein the welding groove is welded to a pole terminal of the cell.

19. The battery pack according to claim 18, wherein
the busbar body is provided with a regional partition line;
the regional partition line divides a top surface of the busbar body into a first region and a second region; and
the welding groove is provided in the first region, and the positioning groove is provided in the second region.

20. The battery pack according to claim 19, wherein a minimum spacing between the regional partition line and the welding groove is 6 mm.
